(19) United States
(12) Patent Application Publication
(10) Pub. No.: US 2021/0347373 A1
(43) Pub. Date: Nov. 11, 2021

(54) CONTROL DEVICE, STRADDLE TYPE VEHICLE, VEHICLE, CONTROL METHOD THEREOF, AND VEHICLE MANAGEMENT SYSTEM

(71) Applicant: HONDA MOTOR CO., LTD., Tokyo (JP)

(72) Inventors: Yotaro MORI, Wako-shi (JP); Keisuke KISHIKAWA, Wako-shi (JP); Kohei NOGUCHI, Wako-shi (JP); Yoshiaki MATSUDA, Wako-shi (JP)

(21) Appl. No.: 17/381,845

(22) Filed: Jul. 21, 2021

Related U.S. Application Data
(63) Continuation of application No. PCT/JP2019/003518, filed on Jan. 31, 2019.

(51) Int. Cl. B60W 50/12; B60W 20/13; G07C 5/00

(52) U.S. Cl. CPC B60W 50/12; G07C 5/008; B60W 20/13

(57) ABSTRACT

An in-vehicle control device comprising a reception unit configured to receive a control signal for controlling a power source of a vehicle, and a control unit configured to control the power source based on the control signal, wherein the control signal includes a start signal for starting the power source in a stop state, a stop signal for stopping the power source in an operation state, and a start restriction signal for restricting a start of the power source based on the start signal, and if the start restriction signal is received during the operation state of the power source, the control unit maintains the power source in the operation state until the stop signal is received.

### CROSS-REFERENCE TO RELATED APPLICATION(S)

This application is a continuation of International Patent Application No. PCT/JP2019/003518 filed on Jan. 31, 2019, the entire disclosures of which is incorporated herein by reference.

### TECHNICAL FIELD

The present invention mainly relates to an in-vehicle control device.

### BACKGROUND ART

As one aspect of a vehicle sales service, there exists a service based on a loan contract. A user who has purchased a vehicle based on a loan contract needs to periodically pay money, and if the payment delays, the use of the vehicle by the user can be restricted (see PTL 1).

### CITATION LIST

### Patent Literature

PTL 1: Japanese Patent No. 6238038

### SUMMARY OF INVENTION

### Technical Problem

As a method of restricting the use of the vehicle, transmitting a signal for requesting the restriction from the server of a sales company to the vehicle can be considered. On the other hand, a case in which the vehicle is already being used by the user when the signal is transmitted from the server to the vehicle can also occur. For this reason, the method of restricting the use of the vehicle needs to be considered even from the viewpoint of usability of the vehicle.

It is an exemplary object of the present invention to relatively easily implement a configuration capable of restricting use of a vehicle as needed while maintaining usability.

### Solution to Problem

The first aspect of the present invention is related to a control device, and the control device is an in-vehicle control device comprising a reception unit configured to receive a control signal for controlling a power source of a vehicle, and a control unit configured to control the power source based on the control signal, wherein the control signal includes a start signal for starting the power source in a stop state, a stop signal for stopping the power source in an operation state, and a start restriction signal for restricting a start of the power source based on the start signal, and if the start restriction signal is received during the operation state of the power source, the control unit maintains the power source in the operation state until the stop signal is received.

### Advantageous Effects of Invention

According to the present invention, it is possible to restrict use of a vehicle as needed while maintaining usability.

### BRIEF DESCRIPTION OF DRAWINGS

FIG. 1 is a block diagram for explaining an example of a system formed by a vehicle, a user thereof, and a sales company;

FIG. 2 is a block diagram for explaining an example of a vehicle configuration capable of controlling a power source;

FIG. 3 is a flowchart for explaining an example of the control contents of the power source by a control device;

FIG. 4 is a block diagram for explaining another example of the vehicle configuration including the control device; and

FIG. 5 is a block diagram for explaining still another example of the vehicle configuration including the control device.

### DESCRIPTION OF EMBODIMENTS

Embodiments will now be described in detail with reference to the accompanying drawings. Note that the following embodiments are not intended to limit the present invention determined by the scope of claims, and not all the combinations of features described in the embodiments are essential to the present invention. Of a plurality of features described in the embodiments, two or more features may arbitrarily be combined. In addition, the same reference numerals denote the same or similar parts, and a repetitive description will be omitted.

### First Embodiment

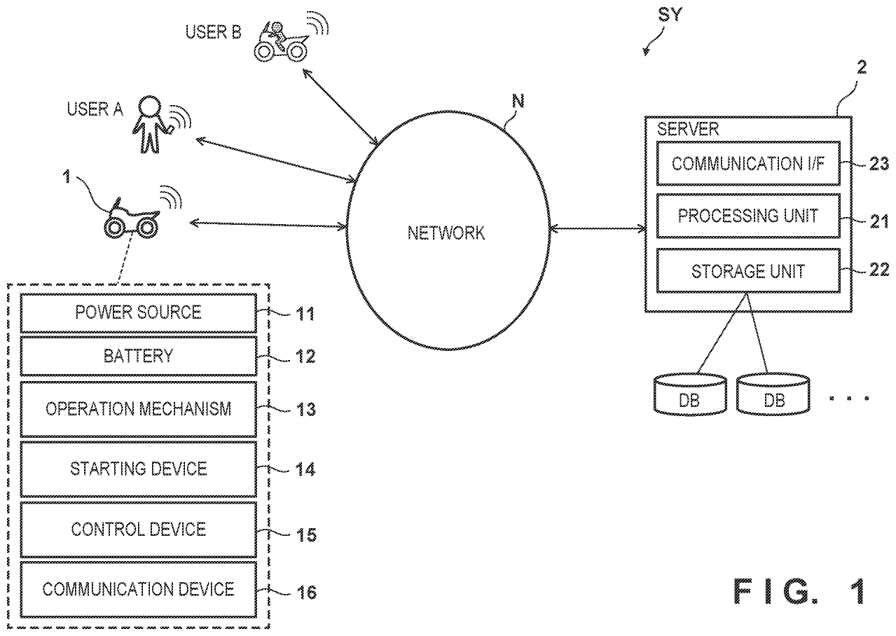

FIG. 1 shows an example of the configuration of a vehicle use service system SY according to the first embodiment. The system SY includes one or more vehicles 1, users thereof (for example, users A and B), and a server 2 of a management company, which can communicate with these via a network N.

The vehicle 1 is a straddle type vehicle in this embodiment but may be a riding type vehicle as another embodiment. Note that the straddle type vehicle indicates a type that a driver rides while straddling the vehicle body, and the concept includes not only a typical motorcycle (including a scooter-type vehicle) but also a three-wheeled vehicle (a vehicle with one front wheel and two rear wheels or a vehicle with two front wheels and one rear wheel), and an all terrain vehicle (ATV) such as a four-wheeled buggy.

The vehicle 1 includes a power source 11, a battery 12, an operation mechanism 13, a starting device 14, a control device 15, and a communication device 16. In this embodiment, the power source 11 is an internal combustion engine (engine). However, as another embodiment, an electric motor such as a three-phase induction motor may be used as the power source 11. A secondary battery that can be charged based on the power of the power source 11 is used as the battery 12. Examples are a lead storage battery, a lithium ion battery, and a nickel hydrogen battery.

The operation mechanism 13 is configured to be able to input an operation for controlling the power source 11 and, for example, outputs a predetermined control signal to the control device 15 (to be described later) based on an operation input by the user A. Examples of the operation input to the operation mechanism 13 are a rotating operation using a predetermined key (an ignition key, a remote key, or the like) corresponding to the vehicle 1, and a pressing operation using a press type switch (a start switch, or the like).

Based on the operation input to the operation mechanism 13, the starting device 14 can start the power source 11 and set it in an operation state, and can also stop the power source 11 in the operation state. A known ignition device including an igniter or the like is preferably used as the starting device 14.

As will be described later in detail, the control device 15 is an ECU (Electronic Control Unit) capable of performing operation control of the entire vehicle 1, and can, for example, transmit/receive signals to/from each constituent element of the vehicle 1 via a predetermined signal line. As an example, the control device 15 can receive a control signal according to an operation input to the operation mechanism 13 and cause the starting device 14 to start the power source 11.

The functions of the control device 15 can be implemented by either hardware or software. For example, the functions of the control device 15 may be implemented by executing a predetermined program by a CPU (Central Processing Unit) using a memory. Alternatively, the functions of the control device 15 may be implemented by a known semiconductor device such as a PLD (Programmable Logic Device) or an ASIC (Application Specific Integrated Circuit). The control device 15 is shown here as a single element. However, the control device 15 may be divided into two or more elements as needed.

The communication device 16 includes a TCU (Telematics Control Unit) that performs signal processing for performing communication with the network N, and the like, and the TCU includes an antenna configured to implement the communication with the network N. From the viewpoint of the control device 15, the control device 15 can communicate with the server 2 (to be described later) by the communication device 16 via the network N. Note that some of the functions of the TCU may be provided in the control device 15, and some of the functions of the control device 15 may be provided in the TCU.

The server 2 includes a processing unit 21, a storage unit 22, and a communication interface unit 23 and can be installed in, for example, the office of a management company that provides a vehicle use service. The processing unit 21 is a processor including a CPU and a memory, and the storage unit 22 is an HDD (Hard Disk Drive) having a relatively large capacity. Note that the storage unit 22 may be distributedly arranged on the network N (may be implemented on a so-called cloud).

For example, the processing unit 21 can communicate with the vehicle 1 by the communication interface unit 23 via the network N, store information about the vehicle 1 in the storage unit 22, or read out the information from the storage unit 22. The processing unit 21 can also communicate with the terminal (a portable terminal such as a smartphone) of the user A of the vehicle 1, store information about the user A in the storage unit 22, or read out the information from the storage unit 22. The information about the vehicle 1 and the information about the user A are associated with each other to form a database DB concerning the vehicle 1 and the user A. Similarly, the database DB is also formed even for each of the other user B during driving and other users (not shown).

In the vehicle use service system SY, the server 2 of the management company can communicate with the vehicle 1, the user A, and the like and perform predetermined management. Examples of the vehicle use service are a vehicle sales service and a vehicle rental service, and examples of the management by the management company are permission and restriction of use of the vehicle 1 for a user. The system SY can also be expressed as a vehicle management system.

For example, in a case in which vehicle sales based on a loan contract is done between the management company and the user A, the server 2 of the management company can permit the user A to use the vehicle 1 while appropriate payment is being done by the user A and restrict the use if the payment delays. As an example, the server 2 manages the state of payment by the user A on the database DB. If the payment delays, the server 2 transmits a signal for requesting to make the vehicle 1 unusable, for example, a signal for requesting restriction of the start of the power source 11 to the vehicle 1 of the user A. In the vehicle 1, in accordance with the reception of the signal from the server 2 by the communication device 16, the control device 15 can suppress the start of the power source 11 by the starting device 14.

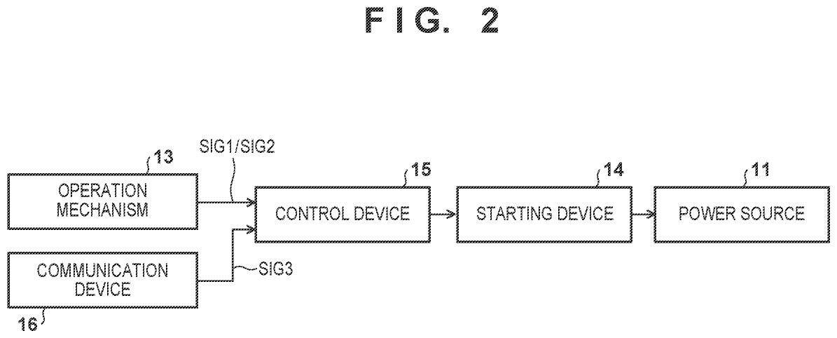

FIG. 2 shows an example of a configuration capable of controlling the power source 11 in the vehicle 1 according to this embodiment. The control device 15 receives signals from the operation mechanism 13 and the communication device 16 and controls (starts/stops) the power source 11 by the starting device 14 based on the signal/signals.

The operation mechanism 13 can selectively output a start signal SIG1 and a stop signal SIG2 as control signals for controlling the power source 11. The start signal SIG1 is a control signal for starting the power source 11 in a stop state. The stop signal SIG2 is a control signal for stopping the power source 11 in an operation state. For example, if an operation of instructing the start of the power source 11 is input to the operation mechanism 13, the operation mechanism 13 outputs the start signal SIG1 to the control device 15. For example, if an operation of instructing the stop of the power source 11 is input to the operation mechanism 13, the operation mechanism 13 outputs the stop signal SIG2 to the control device 15. As will be described later in detail, the above-described control signals may be implemented by supply/cutoff of a current. That is, switching of enable/disable of the start of the power source 11 can be implemented by the presence/absence of supply of a current to the control device 15.

The communication device 16 can output a start restriction signal SIG3 as a control signal for controlling the power source 11. As will be described later in detail, the start restriction signal SIG3 is a control signal for restricting the start of the power source 11 based on the start signal SIG1. The start restriction signal SIG3 may be expressed as a disable signal or the like. Alternatively, in another embodiment using reverse logic levels of signals, the start restriction signal SIG3 may be expressed as an enable signal, a start permission signal, or the like.

The control device 15 controls the power source 11 based on the signals SIG1 to SIG3. For example, before the start restriction signal SIG3 is received, the control device 15 starts the power source 11 in accordance with reception of the start signal SIG1, and stops the power source 11 in accordance with reception of the stop signal SIG2. After the start restriction signal SIG3 is received, the control device 15 does not start the power source 11 even if the start signal SIG1 is received. As will be described later in detail, if the power source 11 is in the operation state, the control device 15 does not stop the power source 11 in the operation state even if the start restriction signal SIG3 is received, and maintains the power source 11 in the operation state until the stop signal SIG2 is received.

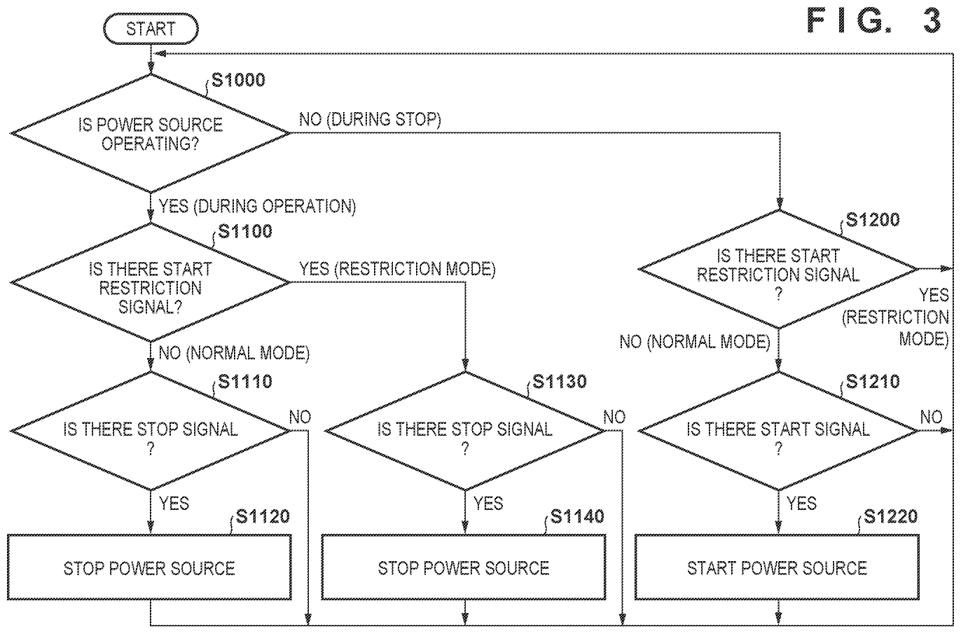

FIG. 3 is a flowchart showing an aspect of control contents by the control device 15. For example, in the above-described case in which vehicle sales based on a loan contract is done between the management company and the user A, the control contents are continued until the payment by the user A is completed, and ended in accordance with completion of the payment. Note that an example of the use form of the vehicle 1 based on the loan contract will be described here, and this also applies to a use form based on another contract such as a rental service.

In step S1000 (to be simply referred to as “S1000” hereinafter, and this also applies to the remaining steps), the control device 15 determines whether the power source 11 is operating. If the power source 11 is operating, the process advances to S1100. Otherwise (in the stop state), the process advances to S1200.

In S1100, the control device 15 determines whether the start restriction signal SIG3 is received. If the start restriction signal SIG3 is received, the process advances to S1130. Otherwise, the process advances to S1110.

In S1110, the control device 15 determines whether the stop signal SIG2 is received. If the stop signal SIG2 is received, the process advances to S1120. In S1120, the control device 15 stops the power source 11 in the operation state and returns to S1000. On the other hand, if the stop signal SIG2 is not received, the process returns to S1000.

In S1130, the control device 15 determines whether the stop signal SIG2 is received, as in S1110. If the stop signal SIG2 is received, the process advances to S1140. In S1140, the control device 15 stops the power source 11 in the operation state and returns to S1000. On the other hand, if the stop signal SIG2 is not received, the process returns to S1000.

In S1200, the control device 15 determines whether the start restriction signal SIG3 is received, as in S1100. If the start restriction signal SIG3 is received, the process returns to S1000. Otherwise, the process advances to S1210.

In S1210, the control device 15 determines whether the start signal SIG1 is received. If the start signal SIG1 is received, the process advances to S1220. In S1220, the control device 15 starts the power source 11 in the stop state and returns to S1000. On the other hand, if the start signal SIG1 is not received, the process returns to S1000.

As a summary, before the start restriction signal SIG3 is received, the control device 15 starts the power source 11 based on the start signal SIG1 and stops the power source 11 based on the stop signal SIG2. If the power source 11 is in the stop state, after reception of the start restriction signal SIG3, the control device 15 does not start the power source 11 in the stop state even if the start signal SIG1 is received. That is, after the control device 15 receives the start restriction signal SIG3, the power source 11 cannot be started. From this viewpoint, the start restriction signal SIG3 can be regarded as an inactivation signal that inactivates the power source 11. On the other hand, if the power source 11 is already in the operation state, the control device 15 does not stop the power source 11 in the operation state even if the start restriction signal SIG3 is received, and maintains the power source 11 in the operation state until the stop signal SIG2 is received.

According to this control method, if the server 2 transmits the signal for requesting to make the vehicle 1 unusable to the vehicle 1 of the user A, and if the vehicle 1 is not being used, it is possible to appropriately make the vehicle 1 unusable. On the other hand, if the vehicle 1 is being used at present, the user is never forced to stop because the vehicle 1 suddenly becomes unusable. That is, if the user A is using the vehicle 1, he/she can continuously use it.

As described above, according to this embodiment, the control device 15 can control the power source 11 based on the signals SIG1 to SIG3. If the start restriction signal SIG3 is received during the operation state of the power source 11, the control device 15 maintains the power source 11 in the operation state until the stop signal SIG2 is received. If the user A is using the vehicle 1, he/she can continuously use the vehicle 1. Hence, according to this embodiment, it is possible to appropriately restrict use of the vehicle 1 while maintaining the usability of the vehicle 1. From the viewpoint of the server 2, the server 2 only transmits, to the vehicle 1, the signal for requesting to make the vehicle 1 unusable, and need not acquire, from the vehicle 1, information representing whether the vehicle 1 is being used. Hence, it can be said that the control contents by the control device 15 according to this embodiment can be implemented relatively easily.

### Second Embodiment

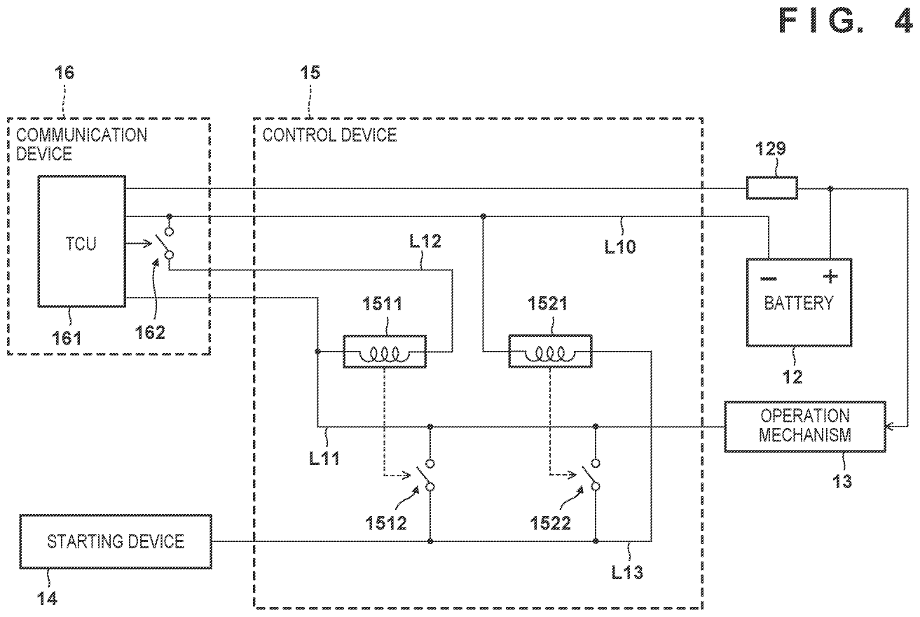

Control (see FIG. 3) by the control device 15 described above in the first embodiment can easily be implemented by software. However, it can also be said that the control can be implemented even by hardware with a relatively simple configuration. FIG. 4 shows an example of the configuration of a vehicle 1 according to the second embodiment.

A control device 15 is implemented by, for example, mounting a plurality of electronic components on a printed board and, in this embodiment, includes inductors 1511 and 1521, and switch elements 1512 and 1522. Each of the inductors 1511 and 1521 generates a magnetic field when a current flows (energization). The inductor 1511 and the switch element 1512 form a relay, and the switch element 1512 is set in a conductive state by a magnetic field generated when the inductor 1511 is energized. Similarly, the inductor 1521 and the switch element 1522 form another relay, and the switch element 1522 is set in a conductive state by a magnetic field generated when the inductor 1521 is energized.

A communication device 16 includes a TCU 161 and a switch element 162, and the TCU 161 can control the switch element 162 to a conductive state or a non-conductive state. As the relationship with the above-described first embodiment, the communication device 16 sets the switch element 162 in the conductive state as the state before the output of a start restriction signal SIG3 to the control device 15, and sets the switch element 162 in the non-conductive state as the state after the output of the signal SIG3. Note that as another embodiment, the switch element 162 may be arranged in the control device 15.

A battery 12 is connected to be able to supply power to each element (in FIG. 4, the positive electrode of the battery 12 is indicated by “+”, and the negative electrode is indicated by “−”). In this embodiment, a protective element 129 (typically, a fuse) is arranged in the positive electrode of the battery 12. The protective element 129 may be arranged at another position, or another protective element may additionally be arranged.

Referring back to the control device 15, the control device 15 further includes wires L10 to L13. The wire L10 is a ground power supply line (may be simply expressed as a “ground line”) connected to the negative electrode of the battery and provides a ground voltage to the control device 15. The wire L10 can be extended up to the communication device 16 and provide the ground voltage to the communication device 16 as well.

The wire L11 is a signal line configured to supply a current (a current based on the power of the battery 12 (to be sometimes expressed as a current in this embodiment)) from the battery 12 provided by an operation mechanism 13. This current corresponds to a signal SIG1/SIG2 from the above-described operation mechanism 13. During the time after the output of the start signal SIG1 from the operation mechanism 13 to the control device 15 and before the output of the stop signal SIG2, the current is supplied to the wire L11.

The wire L12 is a signal line that connects the inductor 1511 and the communication device 16. Here, in the communication device 16, the switch element 162 is arranged between the wires L10 and L12. That is, if the switch element 162 is controlled to the conductive state by the TCU 161, the wires L10 and L12 are electrically connected. From the viewpoint of the inductor 1511 connected to the wire L12, it can be said that before the output of the start restriction signal SIG3 to the control device 15, the communication device 16 can energize the inductor 1511 and set the inductor 1511 in an open state as the output of the signal SIG3.

The wire L13 is a signal line configured to supply a current from the control device 15 to a starting device 14. The switch elements 1512 and 1522 are arranged in parallel between the wire L11 and the wire L13. If at least one of the switch elements 1512 and 1522 is in the conductive state, the wires L11 and L13 are electrically connected. Also, the inductor 1521 is arranged between the wires L10 and L13 and energized when a current is supplied to the wire L13.

According to this configuration, the control device 15 can implement the same control (see FIG. 3) as in the above-described first embodiment.

First, a case in which the switch element 162 is in the conductive state (corresponding to the state before the start restriction signal SIG3 is output from the communication device 16 to the control device 15) will be considered. If the switch element 162 is in the conductive state, the wires L10 and L12 are electrically connected (the wire L12 is grounded). That is, the inductor 1511 is grounded. Here, if an operation input for starting the power source 11 is performed for the operation mechanism 13, the operation mechanism 13 supplies a current to the control device 15 via the wire L11. At this time, the inductor 1511 is grounded and therefore energized, and the switch element 1512 is set in the conductive state by the magnetic field accordingly generated by the inductor 1511. When the switch element 1512 is set in the conductive state, the wires L11 and L13 are electrically connected, and the current is supplied to the wire L13 as well. When the current is supplied to the wire L13, the starting device 14 starts the power source 11 and sets it in the operation state based on the current. Also, when the current is supplied to the wire L13, the inductor 1521 is also energized, and the switch element 1522 is set in the conductive state by the magnetic field accordingly generated by the inductor 1521.

In this state, in a case in which the switch element 162 is set in the non-conductive state (corresponding to the state after the start restriction signal SIG3 is output from the communication device 16 to the control device 15), the wires L10 and L12 are electrically disconnected. That is, the inductor 1511 is set in the open state (or a floating state). Hence, since the inductor 1511 cannot be energized, the current of the wire L11 does not flow to the inductor 1511 anymore, and accordingly, the switch element 1512 is set in the non-conductive state. On the other hand, since the switch element 1522 is in the conductive state, as described above, the current of the wire L11 is supplied to the wire L13 via the switch element 1522. Hence, the inductor 1521 is maintained in the energized state (the switch element 1522 is also maintained in the conductive state). That is, even if the switch element 162 is set in the non-conductive state during the operation of the power source 11 (while the current is supplied to the wire L11), the energized state of the inductor 1521 is maintained, and the switch element 1522 is maintained in the conductive state. This makes it possible to continuously supply the current from the wire L11 to the starting device 14 via the wire L13.

Here, if an operation input for stopping the power source 11 is performed for the operation mechanism 13, the supply of the current to the wire L11 by the operation mechanism 13 is suppressed. Accordingly, the current supplied via the wire L11 and the switch element 1522 does not flow to the wire L13 anymore, and the supply of the current to the starting device 14 is suppressed along with this, and the power source 11 stops.

In this state, the current supplied via the wire L11, the switch element 1522, and the wire L13 does not flow to the inductor 1521 anymore, and accordingly, the switch element 1522 is set in the non-conductive state. That is, since both the switch elements 1512 and 1522 are in the non-conductive state, the wires L11 and L13 are electrically disconnected. Hence, even if the operation input for starting the power source 11 is performed for the operation mechanism 13 again (even if the current is supplied to the wire L11 again), the start of the power source 11 is restricted because the current is not supplied to the wire L13.

As described above, according to this embodiment as well, the same effects as in the first embodiment can be implemented. That is, if a predetermined condition is satisfied in the vehicle use service (for example, if payment based on the loan contract delays), use of the vehicle 1 can appropriately be restricted.

### Third Embodiment

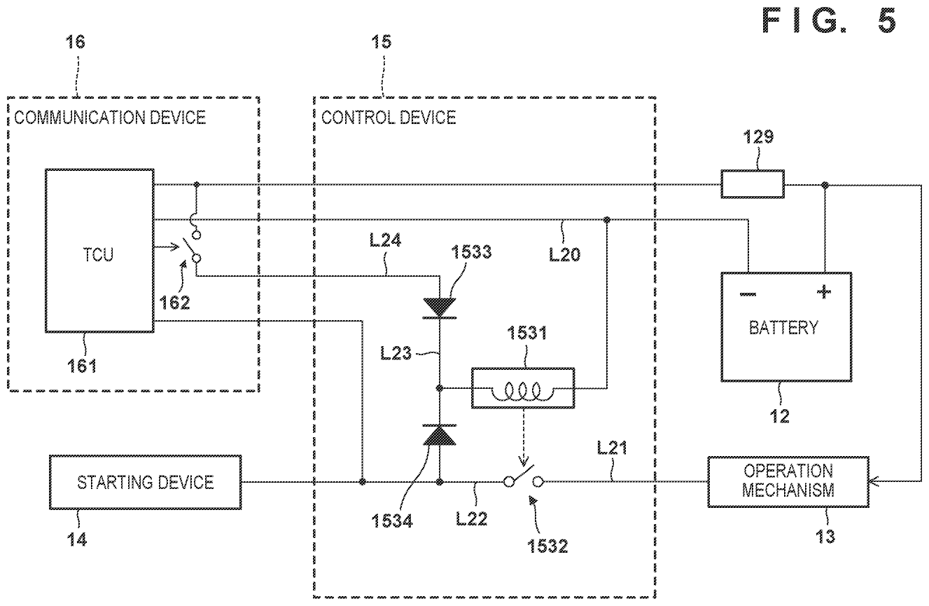

FIG. 5 shows an example of the configuration of a vehicle 1 according to the third embodiment. Control by a control device 15 according to this embodiment can be implemented by hardware with a relatively simple configuration, as in the above-described second embodiment. In this embodiment, the control device 15 includes an inductor 1531, a switch element 1532, rectifying elements 1533 and 1534, and wires L20 to L24.

The inductor 1531 is arranged to be able to receive a current from a communication device 16. The inductor 1531 and the switch element 1532 form a relay, and the switch element 1532 is set in a conductive state by a magnetic field generated when the inductor 1531 is energized. The switch element 1532 set in the conductive state supplies a current supplied by an operation mechanism 13 to a starting device 14, thereby implementing the start of a power source 11.

The current from the communication device 16, which is supplied to the inductor 1531, can be generated based on the power of a battery 12 when a TCU 161 sets a switch element 162 in the conductive state, and the communication device 16 supplies the generated current to the control device 15. In addition, the communication device 16 stops the supply of the current to the control device 15 as the output of a start restriction signal SIG3 to the control device 15.

The rectifying element 1533 is arranged to permit the current from the communication device 16 to flow to the inductor 1531. The rectifying element 1534 is arranged to permit the current that has flowed through the switch element 1532 in the conductive state to flow to the inductor 1531.

The wire L20 is a ground power supply line connected to the negative electrode of the battery and provides a ground voltage to the control device 15. The wire L20 can be extended up to the communication device 16 and provide the ground voltage to the communication device 16 as well. The wire L21 is a signal line configured to supply a current provided by the operation mechanism 13. When the switch element 1532 is set in the conductive state, the wire L22 is electrically connected to the wire L21 and receives the current from the wire L21. The wire L23 is a signal line configured to supply a current to the inductor 1531. That is, the inductor 1531 is arranged between the wires L20 and L23. The wire L24 is a signal line configured to supply the current from the communication device 16 to the wire L23. As is apparent from FIG. 5, the rectifying element 1533 is arranged between the wires L23 and L24, and the rectifying element 1534 is arranged between the wires L22 and L23.

Note that as for the remaining components and functions thereof, the contents of the above-described second embodiment are applied.

According to this configuration, the control device 15 can implement the same control as in the above-described first and second embodiments.

First, a case in which a current is supplied from the communication device 16 to the control device 15 via the wire L24 (corresponding to the state before the start restriction signal SIG3 is output from the communication device 16 to the control device 15) will be considered. Since the current is supplied to the wire L23 via the rectifying element 1533, the inductor 1531 is energized, and the switch element 1532 is set in the conductive state by the magnetic field accordingly generated by the inductor 1531. When the switch element 1532 is set in the conductive state, the wires L21 and L22 are electrically connected. Here, if an operation input for starting the power source 11 is performed for the operation mechanism 13, the operation mechanism 13 supplies a current to the control device 15 via the wire L21. The wire L22 receives the current from the wire L21 via the switch element 1532 in the conductive state, and the starting device 14 starts the power source 11 and sets it in the operation state based on the current. In addition, the current of the wire L22 is supplied to the inductor 1531 via the rectifying element 1534, and this maintains the switch element 1532 in the conductive state.

In this state, if the supply of the current from the communication device 16 to the control device 15 is suppressed (corresponding to the state after the start restriction signal SIG3 is output from the communication device 16 to the control device 15), the current from the communication device 16 does not flow to the inductor 1531. On the other hand, the current from the operation mechanism 13, which is supplied via the wire L21, the switch element 1532, and the wire L22, is supplied to the inductor 1531 via the rectifying element 1534. Hence, even if the supply of the current from the communication device 16 to the control device 15 is suppressed, the switch element 1532 is still maintained in the conductive state. That is, even if the supply of the current from the communication device 16 to the control device 15 is suppressed during the operation of the power source 11 (while the current is supplied to the wire L21), the energized state of the inductor 1531 is maintained, and the switch element 1532 is maintained in the conductive state. From the viewpoint of the rectifying element 1534, it can be said that during the conductive state of the switch element 1532, the rectifying element 1534 supplies the current to the inductor 1531, thereby maintaining the switch element 1532 in the conductive state. This makes it possible to continuously supply the current from the wire L21 to the starting device 14 via the wire L22.

Here, if an operation input for stopping the power source 11 is performed for the operation mechanism 13, the supply of the current to the wire L21 by the operation mechanism 13 is suppressed. Accordingly, the current supplied via the wire L21 and the switch element 1532 does not flow to the wire L22 anymore, and the supply of the current to the starting device 14 is suppressed along with this, and the power source 11 stops.

In this state, since the current does not flow to the inductor 1531, either, and the switch element 1532 is thus set in the non-conductive state, the wires L21 and L22 are electrically disconnected. Hence, even if the operation input for starting the power source 11 is performed for the operation mechanism 13 again (even if the current is supplied to the wire L21 again), the start of the power source 11 is restricted because the current is not supplied to the wire L22.

As described above, according to this embodiment as well, the same effects as in the first and second embodiments can be implemented. That is, if a predetermined condition is satisfied in the vehicle use service (for example, if payment based on the loan contract delays), use of the vehicle 1 can appropriately be restricted.

Summarizing the second and third embodiments in which the control device 15 is formed by hardware, if the start signal SIG1 is received before reception of the start restriction signal SIG3, the control device 15 supplies the current to the starting device 14, thereby starting the power source 11. If the start restriction signal SIG3 is received during execution of the supply of the current (during the operation of the power source 11), the control device 15 maintains the supply of the current, that is, maintains the power source 11 in the operation state until the stop signal SIG2 is received. If the start restriction signal SIG3 is received while the supply of the current is not being executed (during the stop of the power source 11), the control device 15 restricts the start of the power source 11 by inhibiting supply of the current to the starting device 14 even if the start signal SIG1 is received. It can be said that the control device 15 configured to be able to implement such an operation can appropriately be applied to the typical vehicle 1 including the battery 12 and the starting device 14, and the same effects as in the first embodiment can be implemented by a relatively simple configuration.

In the above description, to facilitate understanding, the elements have names associated with their functions. However, the elements are not limited to those having the contents described in the embodiments as main functions, and may have the functions auxiliarily. For example, in this specification, the straddle type vehicle 1 has been described as a typical example. However, the contents of the embodiments can be applied to a variety of vehicles, and can also be applied to one without wheels (for example, a ship or the like). That is, it can be said that the contents of the embodiments can be applied to a variety of moving bodies.

### Summary of Embodiment

The first aspect is related to a control device (for example, 15), and the control device is an in-vehicle control device comprising a reception unit (for example, S1100, S1110, S1130, S1200, and S1210) configured to receive a control signal for controlling a power source (for example, 11) of a vehicle (for example, 1), and a control unit (for example, S1120, and the like) configured to control the power source based on the control signal, characterized in that the control signal includes, a start signal (for example, SIG1) for starting the power source in a stop state, a stop signal (for example, SIG2) for stopping the power source in an operation state, and a start restriction signal (for example, SIG3) for restricting a start of the power source based on the start signal, and if the start restriction signal is received during the operation state of the power source, the control unit maintains the power source in the operation state until the stop signal is received (for example, S1100, S1130, S1140). Accordingly, if a user is using the vehicle, he/she can continuously use the vehicle. Hence, according to the first aspect, it is possible to relatively easily implement a configuration capable of restricting use of the vehicle as needed while maintaining usability.

In the second aspect, the control device is characterized in that the control unit controls the power source based on the start signal and the stop signal before the start restriction signal is received (for example, S1110, S1120, S1210, S1220), and restricts the start of the power source based on the start signal if the start restriction signal is received during the stop state of the power source (for example, S1200). Hence, if a predetermined condition is satisfied, use of the vehicle can appropriately be restricted.

The third aspect is related to a straddle type vehicle (for example, 1), and the vehicle is a straddle type vehicle comprising the above-described control device (for example, 15), and an operation mechanism (for example, 13) configured to be able to input an operation for controlling a power source, characterized in that the operation mechanism outputs a start signal and a stop signal to the control device based on an operation input by a user. That is, the control device can be applied to a typical straddle type vehicle.

In the fourth aspect, the straddle type vehicle is characterized by further comprising a communication device (for example, 16) configured to be communicable with a server (for example, 2), wherein the communication device outputs a start restriction signal to the control device in accordance with reception of a signal for requesting to restrict use of a vehicle from the server. Hence, if a predetermined condition is satisfied, use of the vehicle can appropriately be restricted.

In the fifth aspect, the straddle type vehicle is characterized by further comprising a battery (for example, 12), and a starting device (for example, 14) configured to start the power source using a current from the battery, wherein the control device is configured to supply the current to the starting device in a case in which the start signal is received from the operation mechanism before the start restriction signal is received from the communication device, to maintain supply of the current in a case in which the start restriction signal is received from the communication device during execution of supply of the current, and not to supply the current to the starting device even if the start signal is received from the operation mechanism in a case in which the start restriction signal is received from the communication device while the supply of the current is not being executed. That is, the control device can appropriately be applied to a typical vehicle including a battery and a starting device.

In the sixth aspect, the straddle type vehicle is characterized in that the control device includes a first inductor (for example, 1511) configured to receive the current from the battery, a first switch element (for example, 1512) set in a conductive state by a magnetic field generated by the first inductor and thus configured to be able to supply the current from the battery to the starting device, a second inductor (for example, 1521) configured to receive the current from the battery during the conductive state of the first switch element, and a second switch element (for example, 1522) set in the conductive state by a magnetic field generated by the second inductor and thus configured to be able to supply the current from the battery to the starting device. According to this configuration, if a predetermined condition is satisfied in the typical vehicle, use of the vehicle can appropriately be restricted.

In the seventh aspect, the straddle type vehicle is characterized in that the communication device is configured to, before the start restriction signal is output to the control device, make the first inductor energizable and set the first inductor in an open state as an output of the start restriction signal to the control device. According to this configuration, use of the vehicle can appropriately be restricted.

In the eighth aspect, the straddle type vehicle is characterized in that the communication device is configured to supply a predetermined current to the control device and stop supply of the current as an output of the start restriction signal to the control device, and the control device includes an inductor (for example, 1531) configured to receive the current from the communication device, a switch element (for example, 1532) set in a conductive state by a magnetic field generated by the inductor and thus configured to be able to supply the current from the battery to the starting device, and a rectifying element (for example, 1534) configured to supply the current from the battery to the inductor during the conductive state of the switch element, thereby maintaining the switch element in the conductive state. According to this configuration as well, use of the vehicle can appropriately be restricted.

In the ninth aspect, the straddle type vehicle is characterized in that the straddle type vehicle is a motorcycle (for example, 1) comprising an internal combustion engine (for example, 11) as the power source. That is, the control device can be applied to a typical motorcycle.

The 10th aspect is related to a vehicle management system (for example, SY), and the system is characterized by comprising the above-described straddle type vehicle (for example, 1), and a server (for example, 2) capable of communicating with the vehicle. According to the 10th aspect, it is possible to relatively easily implement a system capable of restricting use of the vehicle as needed while maintaining usability.

The 11th aspect is related to a vehicle management system (for example, SY), and the system is a vehicle management system comprising a vehicle (for example, 1), and a server (for example, 2) capable of communicating with the vehicle, characterized in that the vehicle comprises a power source (for example, 11), and a control device (for example, 15) capable of controlling the power source based on a control signal, the control signal includes a start signal (for example, SIG1) for starting the power source in a stop state, a stop signal (for example, SIG2) for stopping the power source in an operation state, and a start restriction signal (for example, SIG3) for restricting a start of the power source based on the start signal, the start restriction signal is provided to the control device when the vehicle receives a signal representing a request of use restriction for the vehicle from the server (for example, S1100, S1200), and if the start restriction signal is received during the operation state of the power source, the control device maintains the power source in the operation state until the stop signal is received (for example, 51100, 51130, S1140). According to the 11th aspect, it is possible to relatively easily implement a system capable of restricting use of the vehicle as needed while maintaining usability.

The 12th aspect is related to a control method of a vehicle (for example, 1), and the control method is characterized by comprising a step of receiving a control signal for controlling a power source (for example, 11) of the vehicle (for example, S1100, S1110, S1130, S1200, and S1210), and a step of controlling the power source based on the control signal (for example, S1120, and the like), wherein the control signal includes a start signal (for example, SIG1) for starting the power source in a stop state, a stop signal (for example, SIG2) for stopping the power source in an operation state, and a start restriction signal (for example, SIG3) for restricting a start of the power source based on the start signal, and in the step of controlling the power source, if the start restriction signal is received during the operation state of the power source, the power source is maintained in the operation state until the stop signal is received (for example, S1100, S1130, S1140). According to the 12th aspect, it is possible to appropriately restrict use of the vehicle as needed while maintaining usability.

The 13th aspect is related to a vehicle (for example, 1), and the vehicle is a vehicle comprising a power source (for example, 11) and a control device (for example, 15), characterized in that the control device comprises a reception unit (for example, S1100, S1110, S1130, S1200, and S1210) configured to receive a control signal for controlling the power source, and a control unit (for example, 51120, and the like) configured to control the power source based on the control signal, the control signal includes a start signal (for example, SIG1) for starting the power source in a stop state, a stop signal (for example, SIG2) for stopping the power source in an operation state, and a start restriction signal (for example, SIG3) for restricting a start of the power source based on the start signal, and if the start restriction signal is received during the operation state of the power source, the control unit maintains the power source in the operation state until the stop signal is received (for example, S1100, S1130, S1140). According to the 13th aspect, it is possible to appropriately restrict use of the vehicle as needed while maintaining usability.

The invention is not limited to the foregoing embodiments, and various variations/changes are possible within the spirit of the invention.

1. An in-vehicle control device comprising a reception unit configured to receive a control signal for controlling a power source of a vehicle, and a control unit configured to control the power source based on the control signal, wherein
the control signal includes:
a start signal for starting the power source in a stop state;
a stop signal for stopping the power source in an operation state; and
a start restriction signal for restricting a start of the power source based on the start signal, and
if the start restriction signal is received during the operation state of the power source, the control unit maintains the power source in the operation state until the stop signal is received.

2. The control device according to claim 1, wherein
the control unit
controls the power source based on the start signal and the stop signal before the start restriction signal is received, and
restricts the start of the power source based on the start signal if the start restriction signal is received during the stop state of the power source.

3. A straddle type vehicle comprising a control device defined in claim 1, and an operation mechanism configured to be able to input an operation for controlling a power source, wherein
the operation mechanism outputs a start signal and a stop signal to the control device based on an operation input by a user.

4. The straddle type vehicle according to claim 3, further comprising
a communication device configured to be communicable with a server,
wherein the communication device outputs a start restriction signal to the control device in accordance with reception of a signal for requesting to restrict use of a vehicle from the server.

5. The straddle type vehicle according to claim 4, further comprising a battery, and a starting device configured to start the power source using a current from the battery,
wherein the control device is configured
to supply the current to the starting device in a case in which the start signal is received from the operation mechanism before the start restriction signal is received from the communication device,
to maintain supply of the current in a case in which the start restriction signal is received from the communication device during execution of supply of the current, and
not to supply the current to the starting device even if the start signal is received from the operation mechanism in a case in which the start restriction signal is received from the communication device while the supply of the current is not being executed.

6. The straddle type vehicle according to claim 5, wherein the control device includes:
a first inductor configured to receive the current from the battery;
a first switch element set in a conductive state by a magnetic field generated by the first inductor and thus configured to be able to supply the current from the battery to the starting device;
a second inductor configured to receive the current from the battery during the conductive state of the first switch element; and
a second switch element set in the conductive state by a magnetic field generated by the second inductor and thus configured to be able to supply the current from the battery to the starting device.

7. The straddle type vehicle according to claim 6, wherein the communication device is configured to, before the start restriction signal is output to the control device, make the first inductor energizable and set the first inductor in an open state as an output of the start restriction signal to the control device.

8. The straddle type vehicle according to claim 5, wherein the communication device is configured to supply a predetermined current to the control device and stop supply of the current as an output of the start restriction signal to the control device, and
the control device includes:
an inductor configured to receive the current from the communication device;
a switch element set in a conductive state by a magnetic field generated by the inductor and thus configured to be able to supply the current from the battery to the starting device; and
a rectifying element configured to supply the current from the battery to the inductor during the conductive state of the switch element, thereby maintaining the switch element in the conductive state.

9. The straddle type vehicle according to claim 3, wherein the straddle type vehicle is a motorcycle comprising an internal combustion engine as the power source.

10. A vehicle management system comprising a straddle type vehicle defined in claim 3, and a server capable of communicating with the vehicle.

11. A vehicle management system comprising a vehicle, and a server capable of communicating with the vehicle, wherein
the vehicle comprises a power source, and a control device capable of controlling the power source based on a control signal,
the control signal includes:
a start signal for starting the power source in a stop state;
a stop signal for stopping the power source in an operation state; and
a start restriction signal for restricting a start of the power source based on the start signal,
the start restriction signal is provided to the control device when the vehicle receives a signal representing a request of use restriction for the vehicle from the server, and
if the start restriction signal is received during the operation state of the power source, the control device maintains the power source in the operation state until the stop signal is received.

12. A control method of a vehicle, comprising:
a step of receiving a control signal for controlling a power source of the vehicle; and
a step of controlling the power source based on the control signal,
wherein the control signal includes:
a start signal for starting the power source in a stop state;
a stop signal for stopping the power source in an operation state; and
a start restriction signal for restricting a start of the power source based on the start signal, and
in the step of controlling the power source, if the start restriction signal is received during the operation state of the power source, the power source is maintained in the operation state until the stop signal is received.

13. A vehicle comprising a power source and a control device, wherein
the control device comprises:
a reception unit configured to receive a control signal for controlling the power source; and
a control unit configured to control the power source based on the control signal,
the control signal includes:
a start signal for starting the power source in a stop state;
a stop signal for stopping the power source in an operation state; and
a start restriction signal for restricting a start of the power source based on the start signal, and
if the start restriction signal is received during the operation state of the power source, the control unit maintains the power source in the operation state until the stop signal is received.
